(19) United States
(12) Patent Application Publication
(10) Pub. No.: US 2003/0154264 A1
(43) Pub. Date: Aug. 14, 2003

(54) Method and gateway for performing on line switching of software in a communication system

(76) Inventors: Peter N Martin, Swanage (GB); Icarus Sparry, San Jose, CA (US); William A Lindsay, Poole (GB); Keith M Lane, Canford Heath, Poole (GB); Robert H Green, Poole (GB)

Correspondence Address: Kirschstein Ottinger Israel & Schiffmiller, 489 Fifth Avenue, New York, NY, 10017-6105, US

(21) Appl. No.: 10/275,187

(22) PCT Filed: Apr. 27, 2001
(86) PCT No.: PCT/GB01/01912

(30) Foreign Application Priority Data
May 4, 2000 (GB) 0010706.0

(51) Int. Cl. G06F 15/177

(52) U.S. Cl. 709/221

(57) ABSTRACT

The invention provides a method of performing online switching of software from executing a first version of operating software to executing a second version of operating software in a communication system (100). The system (100) incorporates connection gateways (130, 200) controllable using the software for routing and processing communication traffic flowing between subscribers connected to the system (100) in response to subscriber demand. The method includes the steps of: providing the system (100) with its gateways executing the first version of the software; receiving the second version of software at the gateways; receiving an instruction at the gateways to perform an online switch of software; storing persistent data describing at least routing connections established through the gateways; transferring control of the gateways from the first version of software to Mini Media Handler (MMH) software executing in the gateways and operable to maintain established routing connections through the gateways; executing the second version of software concurrently with the MMH software to enabling the second version to recover the persistent data and configure itself in response thereto; and passing control of the gateways from the MMH software to the second version of software. The invention provides the advantage that the gateways can be switched from executing the first version of software to executing the second version of software without causing an interruption of communication traffic conveyed through the gateways.

The present invention relates to a method of performing online switching of software in a communication system, in particular, but not exclusively, to a method of switching in a communication system including software controlled connection gateways from an earlier software build to a later software build whilst the system is in operation conveying communication traffic; the invention further relates to a communication system and a connection gateway operating according to the method.

Conventional communication systems vary in size and complexity. Larger systems have associated therewith numerous subscribers and are capable of routing data along communication paths connecting the subscribers in response to subscriber demand. The paths are established under software control through units known as connection gateways. Such gateways perform routing functions as well as other functions such as data filtration, data reformatting and data encryption or decryption.

When upgrading software in the conventional systems, connection gateways therein executing current versions of software are interrupted or momentarily powered down and then new versions of software are loaded into them and subsequently executed. Such interruption or powerdown causes interruption of services provided in the systems and potential loss of established communication paths therein. Moreover, such interruption or powerdown can potentially appear as system unreliability to subscribers.

The inventors have appreciated that it is desirable to perform online switching between versions of software in communications systems including connection gateways without causing interruption of established communication paths for communication traffic through the systems.

According to a first aspect of the present invention, there is provided a method of performing online switching of software from executing a first version of operating software to executing a second version of operating software in a communication system, the system incorporating connecting means controllable using the software for routing and processing communication traffic flowing between subscribers connected to the system in response to subscriber demand, the method characterised in that it includes the steps of:

(a) providing the system with its connecting means executing the first version of the software;

(b) receiving the second version of software at the connecting means;

(c) receiving an instruction at the connecting means to perform an online switch of software;

(d) storing persistent data describing at least routing connections established through the connecting means;

(e) transferring control of the connecting means from the first version of software to interfacing software executing in the connecting means and operable to maintain established routing connections through the connecting means;

(f) executing the second version of software concurrently with the interfacing software to enable the second version to recover the persistent data and configure itself in response thereto; and

(g) passing control of the connecting means from the interfacing; software to the second version of software.

The present invention also provides a communication system, the system comprising connecting means and software means for controlling the connecting means for routing and processing communication traffic flowing between subscribers connected to the system in response to subscriber demand, in which the software means comprises a first version of the software characterised in that the system also comprises mean, for receiving a second version of the software at the connecting means; means for storing persistent data describing at least routing connections established through the connecting means; interfacing software for executing in the connecting means for maintaining established routing connections through thc connecting means; means for transferring control of the connecting means from the first version of software to interfacing software, means for executing the second version of software concurrently with the interfacing software for enabling the second version to recover the persistent data and to configure itself in response thereto and means for passing control of the connecting means from the interfacing software to the second version of software.

The invention provides the advantage that the connecting mesons is capable of being switched from executing the first version of software to executing the second version of software without causing an interruption of communication traffic conveyed through the connecting means.

The method involves invoking the interfacing software which is advantageously included in the first version of software, the interfacing software operable to control the connecting means without support from other parts of the first version of software. Thus, the interfacing software maintains operation of the connecting means when execution of other parts of the first version of software is terminated.

Persistent data is defined as being data, which includes one or more of:

(a) a record of the state of the connecting means at an instance when the persistent data is stored:

(b) a record of the manner in which the connecting means is included into the system;

(c) licensing data relating to subscribers and users of the system;

(d) a record of all established connections and associated processing functions through the connecting means; and

(e) states of software objects running in the connecting means when the persistent data is stored.

In order to reduce the size and complexity of the persistent data, the first version of software, after step (c) of the method, is operable to render the connecting means unresponsive to new subscriber requests to establish connection. Through the connecting means between subscribers, thereby enabling the connecting meals to attain a stable state with current tasks completed prior to storing the persistent data.

Conveniently, the system includes managing means for downloading the versions of the software to the connecting means and for issuing the instruction in step (c) of the method to perform an online switch of software. Preferably, the managing means is operable to communicate to the connecting means using messages in Ethernet format.

Subscribers often employ incompatible formats for their communication traffic. Thus, beneficially, the connecting means is operable to interface between Ethernet communication traffic and E1 or T1 pulse code modulated (PCM) communication traffic.

In a practical implementation, the connecting means preferably composes a plurality of connection gateways, each gateway including a host processor and an array of digital signal processors (DSPs), the host processor operable to receive routing instructions and to allocate connection routes through the signal processors to provide communication paths between subscribers. The host processor and the array are advantageously housed on a circuit board in relatively close mutual proximity.

Advantageously, the host processor in each gateway is operable to handle Ethernet communication traffic and the DSPs are operable to handle E1 or T1 format PCM communication traffic, the host processor operable to communicate with the DSPs thereby providing translation of communication traffic between Ethernet format and E1 or T1 PCM format through the gateway. Allocating Ethernet traffic processing to the host processor and PCM processing to the DSPs enables the gateway to cope with high rates of communication traffic in the order of 12000 packets/second on Ethernet.

When performing online switching of software, the interfacing software is advantageously operable in steps (e) and (f) of the method to maintain communication traffic flow through the host processor. The DSPs, on account of their associated software stored therein, function to maintain existing established connections therethrough unless instructed to do otherwise. Thus, the interfacing software is capable of ensuring that established connections through the system are uninterrupted when performing the online switching.

In order to allocate processing load more uniformly in each gateway, the array of each gateway incorporates its DSPs grouped in rows, each row hardwired to a respective PCM communication traffic port of the gateway

Advantageously, in order to avoid interrupting execution of the first version of software when the second version of software is loaded into each gateway, the host processor is connected to associated memory means, the second version of software in step (c) being loaded into a second part of the memory means so as not to overwrite the first version of software residing in a first part of the memory means.

Likewise, in order to avoid the versions of software stored in each gateway from overwriting the persistent data stored therein, the host processor is connected to associated memory means for storing in a third part thereof the persistent data in step (d), the third part not overwritten when the first and second version of software are loaded into the memory means.

In order to ensure that established connections through the connecting means are uninterrupted when performing online switching of software, software residing in random access memory of the signal processors and controlling operation of the signal processors remains unupdated in steps (c) to (g) of the method.

When the system is switched to operating using the second version of software rendering the first version obsolete, it is desirable that the first and second versions of software are each capable of rendering the connecting means functional in the system when invoked after a power interruption to the system.

In order for the version of software executing in the connecting means to determine whether or not it is an upgrade or not, the connecting means includes basic operating software stored therein in non-volatile memory, the basic operating software operable to set flagging means for enabling the second version of software to determine from the flagging means whether it is invoked after a power supply interruption to the system or is invoked when performing online switching of software in the system. The flagging means determines, for example, whether or not the version of software executing proceeds to load software into the DSPs; such loading of software into the DSPs is not performed when online switching of software occurs otherwise interruption of established connections would occur.

In a second aspect of the present invention, there is provided a communication system operable according to the aforementioned method of the first aspect of the invention.

In a third aspect of the present invention, there is provided a connection gateway operable according to the aforementioned method of the first aspect of the invention.

Embodiments of the invention will now be described, by way of example only, with reference to the following diagrams in which:

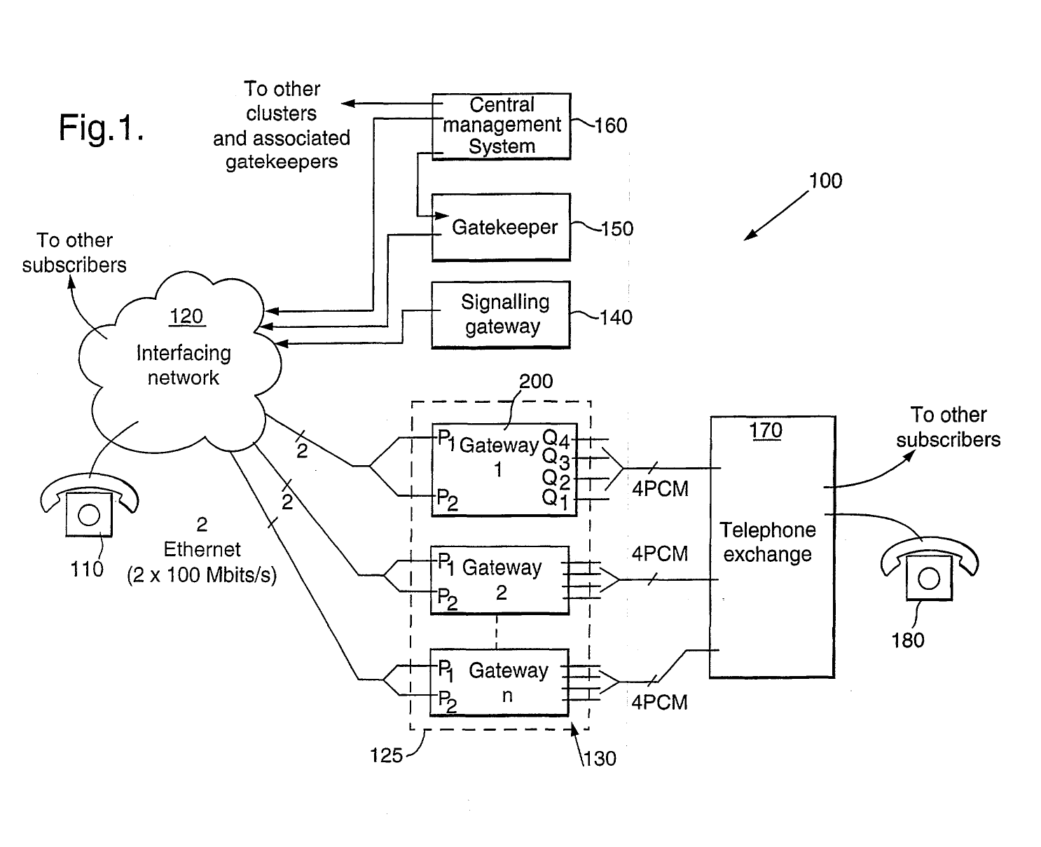

FIG. 1 is a schematic illustration of a communication system incorporating connection gateways according to the invention;

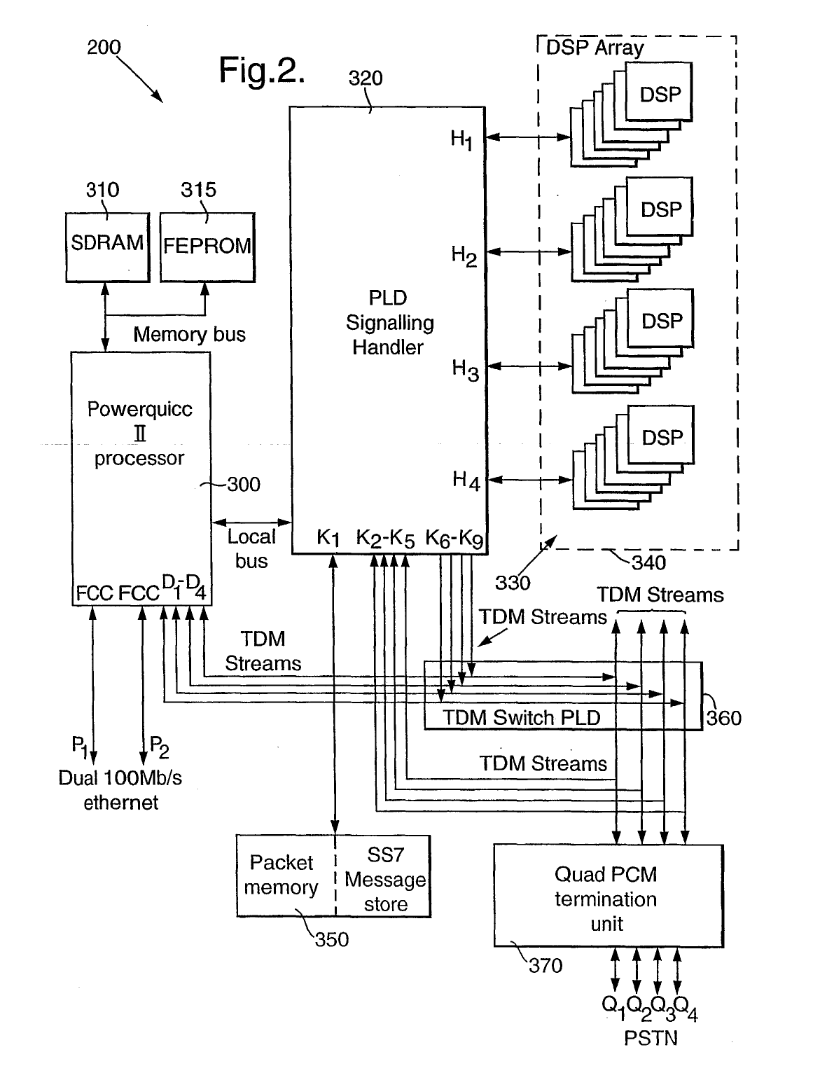

FIG. 2 is a schematic diagram of a connection gateway according to the invention;

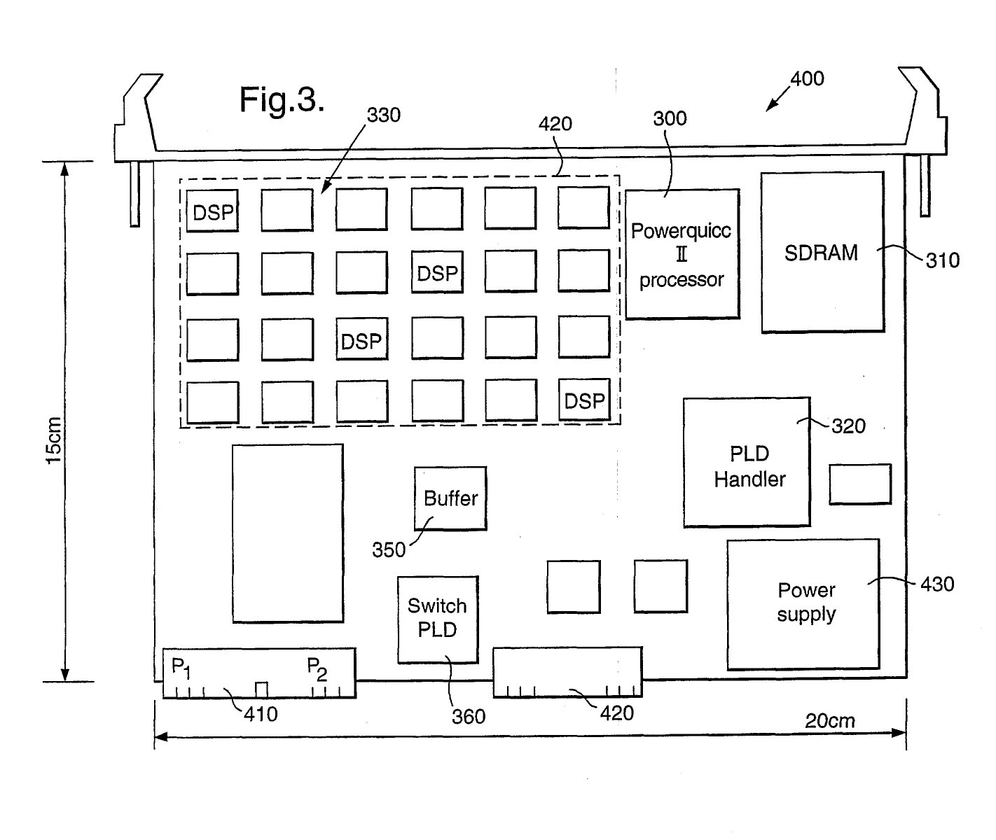

FIG. 3 is a view of a circuit board layout of the gateway illustrated in FIG. 2; and

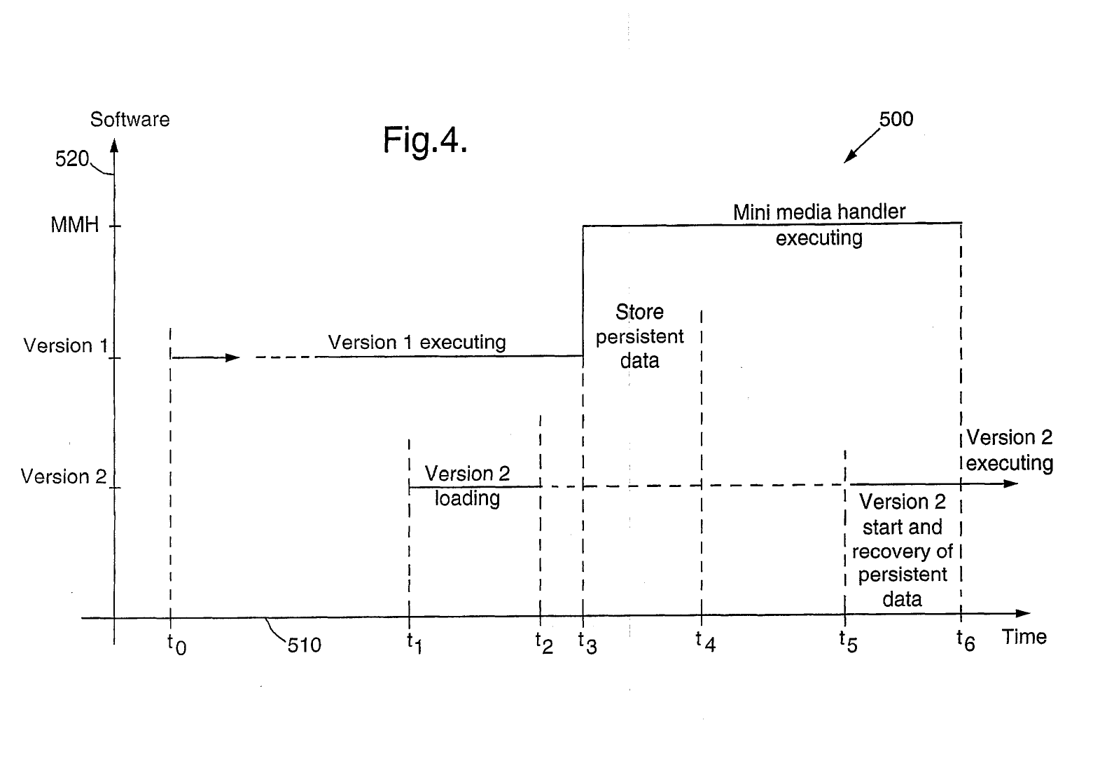

FIG. 4 is a graphical representation of a process executable in the communication system in FIG. 1 for switching from a current version of software to a new version of software.

Communication systems can be configured in, potentially, many alternative ways. FIG. 1 is an illustration of one possible configuration of a communication system according to the invention, the system indicated generally by 100.

The system 100 comprises a first subscriber 110, an interconnection network 120 functioning under internet protocol (IP), and a cluster of connection gateways according to the invention shown included within a dotted line 125, the cluster being indicated by 130. The gateways in the cluster 130 are mutually identical. Moreover, the system 100 further comprises a telephone exchange 170 and a second subscriber 180.

The network 120 is connected to the first subscriber 110 and to other similar subscribers (not shown). Likewise, the exchange 170 is connected to the second subscriber 180 and to other similar subscribers (also not shown). The network 120 is connected to the gateways by Ethernet links.

Each connection gateway, for example a gateway 200, comprises two Ethernet ports P₁, P₂ which are each operable to receive or output Ethernet communication traffic at a rate of 100 Mbits/second. The Ethernet ports P₁, P₂ are connected via the network 120 to the management system 160, to the gatekeeper 150, and to the signaling gateway 140. Each gateway further comprises four pulse code modulation (PCM) ports Q₁, Q₂, Q₃, Q₄ which are connected to respective PCM connection ports of the telephone exchange 170.

Each connection gateway in the cluster 130 incorporates an associated Motorola PowerQuiccII processor. Each PowerQuiccII processor is capable of receiving Ethernet instructions via its associated ports P₁, P₂ from the central management system 160 using simple network management protocol (SNMP). Likewise, each PowerQuiccII processor can respond back to the management system 160 via its associated ports P₁, P₂, for example for providing acknowledgements that instructions have been received by the processor.

Moreover, each PowerQuiccII processor is also capable of receiving Ethernet instructions from the gatekeeper 150. The gatekeeper 150 communicates to the processor using media gateway control protocol (MGCP). Likewise, each processor can respond back to the gatekeeper 150 via its associated ports P₁, P₂. Furthermore, the signaling gateway 140 connects call signaling to the gatekeeper 150 to enable call control.

The management system 160 is also connected to other clusters of gateways and their associated signaling gateways and gatekeepers (not shown). The gatekeeper 150 is thus connected to in a range of 300 to 1000 gateways included within tile cluster 130, namely a parameter “n” in FIG. 1 is in a range of 300 to 1000. The management system 160 thereby is responsible for managing many thousands of connection gateways included in the cluster 130 and the other clusters (not shown)

Operation of the system 100 connecting the subscribers 110, 180 together will now be described with reference to FIG. 1. The first subscriber 110 commences by dialing an access number for contacting the second subscriber 180. The access number propagates from the first subscriber 110 to the network 120 which converts the number into Ethernet format and then outputs it as an Ethernet formatted access number at its Ethernet ports towards the gatekeeper 150. On receipt of the Ethernet formatted number, the gatekeeper 150 determines which gateway in the cluster 130 is available for providing a communication path between the network 120 and the exchange 170. The gatekeeper 150 then sends an instruction in Ethernet format to the ports P₁, P₂ of a gateway, for example to the gate-way 200, to instruct it to provide a communication path from the network 120 to the exchange 170 for the call. The instructed gateway then establishes a communication path therethrough The gatekeeper 150 then communicates the access Lumber to the exchange 170 through the signalling gateway 140 which responds by establishing a communication path from the exchange 170 to the second subscriber 120.

When a complete communication path is established between the subscribers 110, 180, the first subscriber 110 commences by sending message data, for example digitally sampled speech, which is received by the network 120 and converted therein to Ethernet formatted message data. The Ethernet formatted data propagates from the network 120 to the instructed gateway in the cluster 130 at which the message data is converted to corresponding message data in PCM format which is then output to the exchange 170. The exchange 170 proceeds to transmit the PCM formatted message data to the second subscriber 180.

The second subscriber 180 also outputs return data for transmission to the first subscriber 110. The return data propagates from the second subscriber 180 to the exchange 170 whereat it is translated into return data in PCM format. The PCM formatted return data is then transmitted onwards to a gateway in the cluster 130 instructed by the gatekeeper 150 to provide a communication path for the PCM return data to the network 120. The instructed gateway receives the PCM formatted return data and converts it to corresponding Ethernet formatted data which is subsequently output by the instructed gateway at its associated P₁, P₂ ports to the network 120. The network 120 Then routes the Ethernet formatted data onwards to the subscriber 110.

The cluster 130 of gateways, the management system 160, the gatekeeper 150 and the signaling gateway 140 are thus effective at providing a flexible interface between the network 120 and the exchange 170 which operate with mutually different communication data formats. Apart from providing communication paths and translating data format, each gateway in the cluster 130 is capable of performing other functions such as filtration, encryption, decryption and error checking. Each gateway is also operable to provide bi-directional communication, namely from its Ethernet ports to its PCM ports and also from its PCM ports to its Ethernet ports.

When the system 100 is in operation, there is nearly always at least some communication traffic data flowing between subscribers connected to the system 100; as a consequence, the system 100 is rarely inactive. Such lack of inactivity means that the gateways cannot be powered down for software upgrading purposes without interrupting data transmission therethrouh. Conventional connection gateways are not capable of being software upgraded when in operation without disrupting data traffic transmission therethrough. In contrast, the inventors have devised a design of connection gateway and a method of operating such a gateway so that software therein is upgradable without interrupting data transmission through the gateway. In order to further describe the invention and its susceptibility to online software upgrades, the connection gateway 200 according to the invention will now be described with reference to FIG. 2.

The gateway 200 is housed on a multilayer fibreglass circuit board and includes a number of principal parts and associated supporting components; the supporting components comprise power supply regulators, signal conditioners and line drivers and receivers. Such supporting components will be known to one ordinarily skilled in the art of digital circuit design.

The principal parts include a PowerQuiccII processor 300, a synchronous dynamic random access memory (SDRAM) 310, and a field programmable erasable programmable read only memory (FEPROM) 315. The parts further comprise a programmable logic device (PLD) signaling handler 320 and an associated array of twenty-four Motorola digital signal processors (DSP). The DSPs are indicated generally by 330 and shown included within a dotted line 340. The gateway 200 further comprises a memory bluffer 350, a switch PLD 360 and a quad PCM termination unit 370 providing four PCM ports Q₁, Q₂, Q₃, Q₄. In the system 100, the ports Q₁ to Q₄ are connected to corresponding PCM ports of the exchange 170.

The processor 300 is a proprietary MCP8260 Motorola device effectively comprising two interconnected processors on a silicon chip, namely a first processor capable of executing power-PC type machine code, and a second communications control processor designed to handle Ethernet communication and associated input/output stacks. The second processor incorporates hardware that is capable of being configured to handle high-speed data flows, namely Ethernet data streams at a rate in the order of 100 Mbits/second.

Each DSP in the array 330 comprises a proprietary Motorola 56311 digital signal processor device incorporating onboard random access memory RAM). The DSPs are arranged in four rows, each row comprising six DSPs. Each of the four rows is preferably allocated to a corresponding PCM port Q₁ to Q₄.

The principal parts are connected together as shown in FIG. 2. In FIG. 2, the Ethernet ports P₁, P₂ are connected to corresponding FCC ports of the PowerQuiccII processor 300. The processor 300 is connected via a memory bus to its SDRAM 310, to its FEPROM 315 and to a read only memory (ROM) (not shown). The ROM is programmed with basic start-up operating software that the processor 300 executes each time power is initially applied to the gateway 200 to bring it into operation. The processor 300 is further connected via a local bus to the signaling handler 320.

The handler 320 is a programmable gate array customized to function as a hardware backbone in the gateway 200. The handler 320 includes four communication ports H₁, H₂, H₃, H₄ connected to corresponding rows of DSPs. Moreover, the handler 320 farther comprises a port K₁ connected to the memory buffer 350. Furthermore, the handler 320 includes signaling I/FS ports comprising four input ports K₂, K₃, K₄, K₅ and four output ports K₆, K₇, K₈, K₉. The input ports K₂ to K₅ are connected to the switch PLD 360 and also to the PCM termination unit 370. Likewise, the ports K₆ to K₉ are connected to the switch PLD 360. The switch PLD 360 is also connected to ports D₁, D₂, D₃, D₄ of the PowerQuiccII processor 300.

Referring to FIG. 3, there is shown an upper plan view of a circuit board layout of the gateway 200, the board indicated generally by 400. The board has an approximate area of 15 cm by 20 cm. Along a lower edge of the board 400, there is incorporated a connector 410 for the Ethernet ports P₁, P₂. A connector 420 for the PCM ports Q₁ to Q₄ is included centrally along the lower edge. The array 330 of DSPs is incorporated on an upper left-hand side area of the board 400 shown delineated by a dotted line 420. The DSPs are disposed into four rows, each row comprising six DSPs. The handler 320 is situated towards a right-hand side of the board 400. The SDRAM 310 is included in an upper right-hand corner of the board 400. Power regulation components indicated by 430 are incorporated in a lower right-hand corner of the board 400. The buffer 350 and the switch PDL 360 are included towards a central region of the board 400.

An overview of operation of the gateway 200 in the system 100 will now be described with reference to FIGS. 1 and 2. The gateway 200 is capable of receiving or outputting Ethernet traffic at its ports P₁, P₂. The traffic can include one or more of the following:

(a) communication traffic to or from the network 120;

(b) MGCP controlling input instructions from the gatekeeper 150 or from the signaling gateway 140; or

(c) SNMP management instructions from the management system 160.

The PCM traffic flowing between the gateway 200 and the telephone exchange 170 can be in either E1 or T1 format.

The T1 format employs a data frame structure based on a data rate of 1544 kbits/second as defined in the ANSI series of standards T1.111. The T1 frame structure comprises frames where each frame comprises 24 time slots. Each time slot comprises 8 bits of data. Each frame further comprises an associated frame synchronisation “F” bit outside The time slots at the start of each frame indicating frame synchronisation. In addition, a multi-frame synchronisation signal is present for identifying the start of a mu ti-frame comprising 24 frames; such a signal is defined in International Tele-communication Union recommendation ITU-T G.704.

The E1 format employs a data frame structure based on a data rate of 2048 kbits/second. The E1 frame structure comprises 32 time slots, each slot including 8 bits of data; the slots are numbered from slot 0 through to slot 31. Slot 0 is used for frame synchronisation. Moreover, slot 16 is used for SS7 signaling information as defined in recommendation ITU-T Q.703. Slots 1 to 15 are allocated to corresponding communication channels 1 to 15. Likewise, slots 17 to 31 are allocated to corresponding communication channels 16 to 30. Thus, E1 format PCM communication traffic can convey information corresponding to 30 communication channels. On account of the gateway 200 including the four PCM outputs Q₁ to Q₄, the gateway 200 can route any of the channels to the PCM outputs; the gateway 200 is thereby capable of providing 120 possible connection paths therethrough.

The PowerQuiccII processor 300 interprets communication traffic entering at its associated Ethernet ports P₁, P₂ and strips out communication traffic from instructions from the management system 160, or from the gatekeeper 150. The first processor in the PowerQuiccII processor 300 interprets the instructions and responds in a number of ways, for example:

(a) it configures the handler 320 and the DSPs to route channels in a particular manner through the gateway 200, for example channels 1 to 5 from Ethernet traffic provided at the port P₁ to the PCM port Q₃ and apply encryption to the traffic;

(b) it compiles a response message and sends it via one or more of the ports P₁, P₂ back to the management system 160, or to the gatekeeper 150, for example audit responses; or

(c) it loads data or software into specified memory areas of the gateway 200, for example into the SDRAM 310 or RAM associated with the DSPs.

The gateways 200 can be configured such that Ethernet communication traffic entering at its ports P₁, P₂ is directed through the second communications control processor of the PowerQuiccII processor 300 and then out through the local bus to the handler 320 which outputs the traffic to the buffer 350. The traffic stored in the buffer 350 is subsequently output therefrom through the handler 320 again to one or more allocated DSPs in the array 330 which processes the traffic in a manner directed by the gatekeeper 150. When the traffic has been processed in the array 330, it is then output from one or more of the ports K₆ to K₉ of the handler 320 to the switching PLD 360 and further therefrom on to the termination unit 370. The unit 370 conditions the processed traffic for output at one or more of its PCM ports Q₁ to Q₄.

The gateway 200 can also be configured such that PCM communication traffic entering the PCM ports Q₁ to Q₄ is routed and processed in the gateway 200 depending on instructions from the management system 160, from the gatekeeper 150 or from the signaling gateway 140. For example, PCM communication traffic can be routed through the handler 320 to selected DSPs in the array 330 for processing. Corresponding processed traffic from the selected DSPs can then be routed through the handler 320 and its associated buffer 350 and eventually therefrom to the second communication control processor of the PowerQuiccII processor 300 for output therefrom as Ethernet traffic at one or more of its Ethernet ports P₁, P₂.

Thus, the gateway 300 can be configured to support bi-directional communication and processing therethrough.

The inventors have appreciated that software loaded from the management system 160 into connection gateways of the system 100 needs to be updated at intervals for a number of reasons. Such reasons include, for example, adding further clusters or changing a manner in which PowerQuiccII processors in the gateways process Ethernet traffic received from the network 120. It is highly desirable that software can be downloaded from the management system 160 into the connection gateways without interrupting communication traffic flowing between the network 120 and the exchange 170. The inventors have devised a method of operating the system 100 and its associated connection gateways to achieve such updating.

In overview, the method involves the inventors incorporating the following features into the design of the connection gateways, the features comprising:

(a) partitioning the SDRAM 310 into three parts, a first part for storage of current operating software, a second part for storage of new operating software to be executed in substitution for the current software, and a third part for storing persistent data corresponding to status of the gateway and its connection relationship to the system 100; and

(b) including a special software object, namely a Mini Media Handler (MMH), into the current and new operating software stored in the SDRAM 310, the MMH invokable when transferring gateway operation from one version of operating software to another.

The MMH has a special characterstic that it can maintain operation of its associated connection gateway when a transition from the current software to the new software occurs. Moreover, the MMH does not require support of routines included within the current or new software to keep its associated gateway functional; thus, the MMH can continue functioning even if its associated operating software has ceased execution.

Operation of the system 100 downloading a current version of operating software into its connection gateways and then upgrading the current version of software to a new version will now be described with reference to FIGS. 1 and 2.

Initially when power is applied to the network 100, none of the connection gateways in the cluster 130 have operating software loaded thereinto; each of them only includes the aforementioned start-up operating software stored in associated on-board ROM. Initially, by executing the start-up software, the PowerQuiccII processor 300 in each gateway outputs data at its associated Ethernet ports P₁, P₂ making its presence in the system 100 known to the management system 160 Similarly, the gatekeeper 150 and the signaling gateway output data to make their presence known to die management system 160.

The system 160 proceeds to load operating software into the gatekeeper 150 and into the signaling gateway 140. The management system 160 further proceeds to issue a current version of operating software to each of the gateways in the cluster 130 via their associated Ethernet ports P₁, P₂. The current operating software is loaded into a first part of the SDRAM 310 of each gateway in the cluster 130. In each gateway, a portion of the operating software is then transferred from its associated PowerQuiccII processor 300 into RAM associated with each of its associated DSPs in the array 330. Each DSP has mutually identical software loaded into its associated RAM; however, if specifically necessary, each gateway in the cluster 130 is capable of being programmed so that its DSPs can be loaded with mutually different software although this is not a usual mode of operation. Software loaded into the DSPs is designed to enable the DSPs to interface to the handler 320 and to perform a range of signal processing functions, for example signal filtration, reformatting, encryption, decryption, compression and decompression functions. Conversely, software residing in the first part of the SDRAM 310 is for execution in the PowerQuiccII processor 300 of each connection gateway and is operable to interface toe processor 300 to the management system 160, to the gatekeeper 150, to the signaling gateway 140 and enable the processor 300 to interpret commands and configure and connect its associated DSPs to perform desired routing and processing functions.

The software residing in the first part of the SDRAM of each gateway in the cluster 130 also includes the special software object, namely the Mini Media Handler (MMH). The MMH is normally inactive and is only activated by the PowerQuiccII processor 300 on special command from the operating system 160 when an online software switch is about to be performed.

When the current operating software has been loaded into the gateways in the cluster 130 and also into the gatekeeper 150 and the signaling gateway 140, the management system 160 then issues a command for the system 100 to commence operation. The system 100 then functions as described earlier in overview.

When the system 100 has been operational for a period of time, for example several weeks or months, a considerable amount of communication traffic corresponding to calls between subscribers will be flowing through the system 100; for example, it is not unusual for 10000 calls to be simultaneously interfaced through the cluster 130 when it comprises 1000 connection gateways, each gateway providing 120 potential connections when working with E1 format communication traffic. Often, the data flow can be relatively constant and periods where the system 100 is in a quiet state do not occur predictably.

The inventors have appreciated that it is not practicable simply to switch off the system 100 and load new software into it when software upgrades are required because this will cancel all call connections in the system 100 and will appear as unreliability to subscribers. If use of the system 100 is sold to subscribers on the basis of reliability of connection, simply switching off the system 100 momentarily for software upgrading purposes can have serious financial consequences regarding customer billings and therefore revenue derived from the system 100.

The gateways in the cluster 130 have therefore been designed to be capable of having their software upgraded without disturbing established calls routed through the system 100. In overview, a software switching process is invoked on command from the management system 160 when the current version of software being executing in the cluster 130 is to be replaced by a new version of software. The process is illustrated in FIG. 4.

In FIG. 4, there is a graphical representation of a online software switching process executable in the communication system 100 for switching from a current version of operating software to a new version of operating software, the process being represented by a graph indicated by 500; in FIG. 4, “Version 1” and “Version 2” correspond to the current and new versions of operating software respectively. The graph 500 includes an abscissas axis 510 denoting time elapsed from left to right. Moreover, the graph 500 further includes an ordinate axis 520 on which is indicated various items of software.

At a time t₀, power is applied to the system 100 which initially starts up; the basic start-up software in the connection gateways causes them to announce their inclusion in the system 100 via Ethernet to the management system 160. Moreover, the basic software also sets a flag Fₛ in the SDRAM 310 of each connection gateway to record that no previous versions of operating software have yet been loaded into the gateway. After the time t₀, the management system 160 loads a current version of operating software into each of the connection gateways in the cluster 130. As described earlier, the current version of operating software is loaded into a first part of the SDRAM 310 in each connection gateway. Each connection gateway then proceeds to download from its SDRAM 310 via its PowerQuiccII processor 300 past of the current version of operating software into RAM of each of its associated DSPs. The management system 160 then issues an instruction for the system 100 to commence operation to convey communication traffic. The current version of software when executing in each connection gateway initially checks the flag Fₛ. The flag Fₛ is in an unset state as a consequence of action of the basic software; the current version of software identifies from the state of the flag Fₛ that it is not a software upgrade.

At a time t₁, for example several months after the time t₀, its operator instructs the management system 160 that a software update is required in the system 100. The management system 160 proceeds in response to retrieve from its memory a new version of operating software, and then issues an instruction to the connection gateways in the cluster 130 to prime them to receive the new software. The gateways in the cluster 130 then receive from the management system 160 via their Ethernet ports P₁, P₂ the new version of software which they each store in a second part of their SDRAM 310, thereby not overwriting the current version of software stored in the first part of their SDRAM 310. Whilst the new version of software is being downloaded into the gateways, the gateways continue to function by executing their current version of software. At a time t₂, the management system 160 has completed downloading the new version of software into the connection gateways.

At a time t₃, the management system 160 issues a command to the connection gateways in the cluster 130 to perform an online switch to executing the new version of software. This instruction causes each connection gateway executing the current version of software to execute a switchover routine. When executing the switchover routine, each gateway ignores further instructions from the management system 160, or from the gatekeeper 150; the current version of the software invokes its MMH. As aforementioned, the MMH is a special software object which can keep its associated gateway functioning without invoking operating system routines included in the current version of operating software. Moreover, each gateway sets its flag Fₛ to a set state indicative of operating software having already been executed in the gateway after the time t₀. Each gateway then proceeds to wait until its present tasks are concluded, for example subscribers connected thereto have completed their number dialing sequences or have hung up, rendering the gateway in a stable state. When each gateway has attained a stable state, it stores its persistent data describing its current state in a third part of its SDRAM 310. Persistent data will be described more fully later.

At a time t₄ when the connection gateways have stored their associated persistent data, the current version of software ceases executing leaving only the MMH executing. At a time t₅, the MMH invokes the new version of operating software. The MMH and the new version are executed concurrently in a period between the time t₅ and a later time t₆, although during this period the new version does not implement any new connections through the DSPs of its gateway. The new version first checks the flag Fₛ to determine therefrom whether or not the new version has been invoked as an upgrade or whether or not it has been invoked following a power down of the system 100; the flag Fₛ was set as described above hence the new version determines therefrom that it is an upgrade. The new version then proceeds to retrieve the persistent data from its associated SDRAM 310 and load it into a random access memory on its processor 300. If the flag Fs were not set, the new version would interpret therefrom that it was not an upgrade and would not need to search for persistent data.

After retrieving the persistent data and setting its working parameters into accordance with the persistent data, the new version of software then at the time t₆ terminates execution of the MMH provided in the current version of software and assumes control of the gateway. At this stage, each connection gateway is fully under the control of its new version of software and can again receive instructions from the management system 160, and from the gatekeeper 150. The time t₆ signifies the end of the process for online switching of software in the connection gateways.

During the online switching process, software in the DSPs is not upgraded; doing so would potentially interrupt established communication paths through the cluster 130. Moreover, the new version of software, in similarity to the current version, is capable of operating the cluster 130 in the event of the system 100 being powered down and then restarted using the new software; thus, the new version of software includes its own MMH so that a switchover to other software from the new version of software can also be made if subsequently required. The process even allows reversion from the new version of software to the current version in case the new version of software is found to be defective when executed in the system 100, for example if it includes a software bug which only becomes apparent on live execution of the new version of software in the system 100. Such reversion to the current version of software also uses the process as shown in FIG. 4 except that “Version 1” and “Version 2” become the new version of software and the current version of software respectively, the MMH being invoked corresponding to the one included in the new version of software.

In the process represented in FIG. 4, waiting for each gateway to reach a stable state before storing its persistent data simplifies greatly the complexity of the persistent data and also simplifies tasks which the new version of software has to perform in a duration between the times t₅ and t₆. If each gateway is not permitted to reach a stable state, the size of the persistent data is considerably enlarged because it then has to include parameters describing instantaneous status of tasks being executed by the current version of software rather than end states of completed tasks. In practice, the persistent data has a size in the order of 100 kbytes when only end states are recorded therein.

Partitioning the SDRAM 310 of each gateway into first, second and third parts is governed by memory parameters allocated to the versions of software; the SDRAM 310 is a continuous memory without distinct hardwired separate regions. The current and new versions of software are stored in the mutually different first and second parts of the SDRAM 310 and the persistent data is stored in the third part of the SDRAM 310 which is not overwritten when the new version of software is loaded from the management system 160.

If the new version of software is invoked in the system 100 immediately after power being reapplied after a power supply interruption, the new version of software checks the flags Fₛ in each of the connection gateways and will proceed to load software received from the management system 160 to RAM of the DSPs in the event that the flags Fₛ are set to record that no earlier versions of operating software have been executed after power up.

Persistent data stored in the SDRAM 310 of each connection gateway can provide a record of the following parameters:

(a) a current configuration of the gateway, for example whether its ports Q₁, Q₂, Q₃, Q₄ are operable to receive E1 or T1 formatted communication traffic;

(b) configuration data relating to where the gateway is included in the system 100 and to what it is connected;

(c) licensing data relating to subscribers and users of the system 100;

(d) details of all established connections through the DSPs between the PCM ports Q₁ to Q₄ and the ports P₁, P₂, for example which DSP is handling a particular connection through the gateway and the filtration, encryption, decryption, data compression and reformatting functions that the DSP is configured to perform; and

(e) states of software objects running in the PowerQuiccII processor 300 just prior to storing the persistent data.

The Mini Media Handler will now be described in further detail. Unless the DSPs in the connection gateways are instructed to terminate processing functions allocated to them, they will continue to perform their appointed functions; thus, in order to maintain present operation of the DSPs, the MMH does not need to issue new instructions to the DSPs. Moreover, the second communications control processor in each PowerQuiccII processor 300 includes a number of data registers which determine routing of Ethernet data through its associated PowerQuiccII processor 300 into its associated buffer 350. It is the responsibility of the MMH to ensure that these registers are correctly set and that communication traffic flows between the ports P₁, P₂ and the DSPs via the buffer 350 and the handler 320. The MMH also has to be capable of handling a software call at the time t₄ from the current version of software invoking MMH operation and also be capable of passing software control of the gateway over to the new version of operating software when demanded by the new version at the Time t₆. As described earlier, the MMH has to be capable of performing these operations without support from the current and new versions of software.

In practice, the process of online software switching represented in FIG. 4 is relatively rapid; for example, only seconds of time are required for loading the new version of software to the connection gateways in a period of t₁ to t₂, waiting for a stable state and storing persistent data in a period of t₃ to t₄ takes up to seconds because events such as dialing are timed out if not completed within seconds, and MMH execution in a period of t₄ and t₆ lasts in a range of seconds. Transition from executing the current version of software to executing the MMH at the time t₄ occurs within a period which is in the order of time jitter typically observed in Ethernet communication traffic provided from the network 120. Likewise, transition from the MMH to the new version of software it the time t₆ is similarly also in the order of time jitter normally observed in the system 100. As a consequence, switchover from the current version to the new version of software is virtually undetectable by the system 100 except that the connection gateways will appear to be unresponsive to new call requests from the gatekeeper 150 when attempting to reach a stable state just prior to the time t₄; such unresponsiveness does not correspond to interruption of established connections through the system 100 as would occur in prior art communication systems when performing software upgrades Thus, operating the system 100 as described above enables the gateways to be updated with new software online without interrupting operation of the system 100.

Table 1 provides a tabulated list of events of the online software switching process represented graphically in FIG. 4.

TABLE 1

| STEP | TIME | OPERATION |
|---|---|---|
| 1 | t₀ | Power is supplied to the system 100 |
| 2 | | Execution of the basic operating software is commenced in the connection gateways (from |
| | | ROM), in the signaling gateway 140, in the gatekeeper 150 causing them to announce via |
| | | Ethernet their existence in the system 100 to the management system 160 |
| 3 | | The flag F₅ in each connection gateway is set to record that no previous version of operating |
| | | software has been loaded since step 1 |
| 4 | | Operating software is downloaded from the management system 160 into the gatekeeper 150, |
| | | into the signaling gateway 140 and into the first part of the SDRAM 310 of each of the |
| | | connection gateways in the cluster 130 |
| 5 | | Each connection gateway loads software into its associated DSPs |
| 6 | | The management system 160 issues to the system 100 an instruction to commence operation |
| 7 | | The current version of operating software in each connection gateway checks the status of its |
| | | associated flag F₅ and then continues to bring the gateway into operation |
| 8 | t₁ | The management system 160 issues an instruction that the new version of software is about to be |
| | | downloaded |
| 9 | t₂ | The new version of software is downloaded from the management system 160 into the second |
| | | part of the SDRAM 310 of each connection gateway |
| 10 | t₃ | The management system 160 issues a command to the connection gateways to switch over to |
| | | executing the new version of software |
| 11 | | The connection gateways restrict their SNMP command interpretation to providing audits only, |
| | | namely status reports back to the gatekeeper 150 |
| 12 | | The connection gateways restrict their MGCP command interpretation to providing audits only, |
| | | namely status reports back to the gatekeeper 150 |
| 13 | | Each connection gateway sets its associated flag F₅ to record that the current version of software |
| | | has been executed after the time t₀ |
| 14 | | Each gateway completes its present tasks without responding to new requests from the |
| | | gatekeeper 150, from the signaling gateway 140 or from the management system 160; each |
| | | gateway thereby attaining a stable state |
| 15 | | Each connection gateway stores its persistent data corresponding to its stable state in a third part |
| | | of its SDRAM 310 |
| 16 | t₄ | Each connection gateway invokes its MMH software and execution of the current version of |
| | | software is then terminated |
| 17 | t₅ | The new version of software commences execution in each gateway concurrently with the MMH |
| | | software, but full control of the connection gateway is not yet passed to the new version |
| 18 | | In each connection gateway, the new version of software checks its flag F₅ to determine whether |
| | | the new version is an upgrade or invoked in an initial powering up of the system 100 |
| 19 | | In each connection gateway, the new version of software leaves the DSPs, the handler 320 and |
| | | the PowerQuiceII processor 300 SNMP (Ethernet) in their presently established state if the flag |
| | | F₅ is set to indicate that the new version is an upgrade |
| 20 | | In each connection gateway, the new version of software performs a “sanity check” to ensure |
| | | that loss of connection gateway functionality will not occur when the new version of software |
| | | assumes full gateway control; if there is a problem, control remains with the MMH and a report |
| | | is sent back via Ethernet SNMP to the management system 160 |
| 21 | t₆ | In each connection gateway, the MMH passes full gateway control to the new version of |
| | | software; execution of the MMH software is terminated simultaneously with the new version |
| | | assuming full control |
| 22 | | In each connection gateway, the PowerQuiceII processor 300 is rendered by the new software |
| | | fully responsive again to SNMP and MGCP communications received at its associated P₁, P₂ |
| | | Ethernet ports |

It will be appreciated that modifications can be made to the system 100 without departing from the scope of the invention. For example, the DSPs and the PowerQuiccII devices can be replaced by alternative proprietary devices providing similar general data processing and interpretation functions respectively. The PLD handler 320 can be replaced with other semiconductor devices capable of providing an interface between the processor 300 and the DSPs.

Moreover, the current and new versions of software can be structured in a number of alternative ways to control each gateway. Thus, the current and new versions of software can be substituted with alternative versions provided that:

(a) the alternative versions can control their associated connection gateways; and

(b) gateway operation can be transferred between the alternative versions of software by invoking intermediary software, namely the MMH software, and using persistent data storage to record status of the connection gateways at switchover from one version of the software to another.

Other methods of online software updating can be used for upgrading software loaded into the gatekeeper 150 and also into the DSPs of each connection gateway; for example, DSPs can have loaded thereinto software upgrades when they are not actively providing communication connections therethrough.

1. A method of performing online switching of software from executing a first version of operating software to executing a second version of operating software in a communication system (100), the system (100) incorporating connecting means (130, 140, 150) controllable using the software for routine and processing communication traffic flowing between subscribers (110, 180) connected to the system (100) in response to subscriber demand, the method characterised in that it includes the steps of:
(a) providing the system (100) with its connecting means (130) executing the first version of the software;
(b) receiving the second version of software at the connecting means (130);
(c) receiving an instruction at the connecting means (130) to perform an online switch of software;
(d) storing persistent data describing at least routing connections established through the connecting means;
(e) transferring control of the connecting means (130) from the first version of software to interfacing software (MMH) executing in the connecting means (130) and operable to maintain established routing connections through the connecting means (130);
(f) executing the second version of software concurrently with the interfacing software (MMH) to enable the second version to recover the persistent data and configure itself in response thereto; and
(g) passing control of the connecting means from the interfacing software to the second version of software.

2. A method according to claim 1 wherein the interfacing software is included in the first version of software, the interfacing software (MMH) operable to control the connecting means (130) without support from other parts of the first version of software.

3. A method according to claim 1 or 2 wherein the persistent data includes one or more of:
(a) a record of the state of the connecting means (130) at an instance when the persistent data is stored;
(b) a record of the manner in which the connecting means (130, 140, 150) is included into the system (100, 120, 170);
(c) licensing data relating to subscribers (110, 180) and users of the system;
(d) a record of all established connections and associated processing functions through the connecting means (130); and
(e) states of software objects running in the connecting means (130) when the persistent data is stored.

4. A method according to claim 1, 2 or 3 wherein, after step (c), the first version of software is operable to render the connecting means (130) unresponsive to new subscriber requests to establish connections through the connecting means (130) between subscribers (110, 180), thereby enabling the connecting means (130) to attain a stable state with current tasks completed prior to storing the persistent data.

5. A method according to claim 1, 2, 3 or 4 wherein the system (100) includes managing means (160) for downloading the versions of the software to the connecting means (130) and for issuing the instruction in step (c) to perform an online switch of software.

6. A method according to claim 5 wherein the managing means (160) is operable to communicate to the connecting means using messages in Ethernet format.

7. A method according to claim 6 wherein the managing means employs SNMP protocol to communicate to the connecting means (130).

8. A method according to any preceding claim wherein the connecting means (130) is operable to interface between Ethernet communication traffic and E1 or T1 format pulse code modulated (PCM) communication traffic.

9. A method according to any preceding claim wherein the connecting means (130) comprises a plurality of connection gateways (200), each gateway (200) including a host processor (300) and an array (330) of digital signal processors (DSPs), the host processor operable to receive routing instructions and to allocate connection routes through the signal processors to provide communication paths between subscribers (110, 180).

10. A method according to claim 9 wherein the host processor (300) in each gateway (200) is operable to handle Ethernet format communication traffic and the DSPs are operable to handle PCM communication traffic, the host processor (300) operable to communicate with the DSPs thereby providing translation of communication traffic between Ethernet format (P₁, P₂) and PCM E1 or T1 format (Q₁, Q₂, Q₃, Q₄) through the gateway.

11. A method according claim 9 or 10 wherein the interfacing software is operable in steps (e) and (f) to maintain Ethernet communication traffic flow through the host processor (300).

12. A method according to claim 9, 10 or 11 wherein the array (330) of each gateway incorporates its DSPs grouped in rows, each row hardwired to a respective PCM communication traffic port (Q₁, Q₂, Q₃, Q₄) of the gateway.

13. A method according to claim 9, 10, 11 or 12 wherein the host processor (300) is connected to associated memory means (310), the second version of software in step (c) loaded into a second part of the memory means so as not to overwrite the first version of software residing in a first part of the memory means (310).

14. A method according to any one of claims 9 to 13 wherein the host processor (300) is connected to associated memory means (310) for storing in a third part thereof the persistent data in step (d), the third part not overwritten when the first and second versions of software are loaded into the memory means (310).

15. A method according to any one of claims 9 to 14 wherein software residing in random access memory of the signal processors and controlling operation of the signal processors remains unupdated in steps (c) to (g).

16. A method according to any preceding claim wherein the first and second versions of software are both operable to render the connecting means (130) functional in the system (100) when invoked after a power interruption to the system (100).

17. A method according to any preceding claim wherein the connecting means (130) includes basic operating software stored therein in non-volatile memory, the basic operating software operable to set flagging means (Fₛ) for enabling the second version of software to determine from the flagging means (Fₛ) whether it is invoked after a power supply interruption to the system (100) or is invoked when performing online switching of software in the system (100).

18. A communication system (100), the system (100) comprising connecting means (130, 140, 150) and software means for controlling the connecting means for routing and processing communication traffic flowing between subscribers (110, 180) connected to the system (100) in response to subscriber demand, in which the software means comprises a first version of the software characterised in that the system also comprises
means for receiving a second version of the software at the connecting means (130);
means for storing persistent data describing at least routing connections established through the connecting means;
interfacing software (MMH for executing in the connecting means (130) for maintaining established routing connections through the connecting means (130);
means for transferring control of the connecting means (130) from the first version of software to interfacing software (MMH);
means for executing the second version of software concurrently with the interfacing software (MMH) for enabling the second version to recover the persistent data and to configure itself in response thereto; and
means for passing control of the connecting means from the interfacing software (MMH) to the second version of software.

19. The communication system according to claim 18 comprising managing means 160) for downloading the versions of the software to the connecting means (130) and for initializing an online switch of software.

20. The communication system according to claim 18 or 19 wherein the managing means (160) is operable to communicate to the connecting means using messages in Ethernet format.

21. The communication system according to any of claims 18 to 20 wherein the connecting means (130) comprises a plurality of connection gateways (200), each gateway including a host processor (300) and an array (330) of digital signal processors (DSPs), in which each host processor comprises means for receiving routing instructions and for allocating connection routes through the DSPs.

22. The communication system according to claim 21 wherein the host processor (300) in each gateway (200) comprises means to communicate with Ethernet format communication traffic and in which the DSPs comprise means to communicate with PCM communication traffic, in which the host processor (300) comprises means for communication with the DSPs and for translation of communication traffic between Ethernet format P₁, P₂) and PCM E1 or T1 format (Q₁, Q₂, Q₃ Q₄) through the gateway.

23. The communication system according to claim 21 or 22 wherein the array (330) of each gateway comprises the DSPs grouped in rows, in which each row is hardwired to a respective PCM communication traffic port (Q₁, Q₂, Q₃ Q₄) of the gateway.

24. The communications system according to any of claims 21 to 23 wherein each host processor (300) is connected to associated memory means (310), in which the associated memory means comprises a first part for storing the first version of software and a second part for storing the second version of software so that the first part is not overwritten when the second version of software is loaded into the memory means.

25. The communications system according claim 24 in which the associated memory means comprises a third part for storing the persistent data so that the third part is not overwritten when the first and second versions of software are loaded into the memory means (310).

26. The communications system according to any of claims 18 to 25 wherein the connecting means (130) comprises flagging means (Fₛ) and non-volatile memory for storing basic operating software in which the basic operating software is operable to set flagging means (Fₛ) for indicating to the second version of software whether it is invoked after a power supply interruption to the system (100) or is invoked when performing online switching of software in the system (100).

27. A communication system (100) for carrying out the method as claimed in any preceding claim.

28. A connection gateway (200) for carrying out the method as claimed in any one of claims 1 to 17.
